(19) United States
(12) Patent Application Publication
(10) Pub. No.: US 2026/0296332 A1
(43) Pub. Date: Oct. 1, 2026

(54) VEHICLE CEILING INTERIOR MATERIAL

(71) Applicant: Howa Co., Ltd., Kasugai-shi, Aichi (JP)

(72) Inventors: Toshiki HIDA, Kasugai-shi, Aichi-ken (JP); Yuki BAN, Kasugai-shi, Aichi-ken (JP)

(21) Appl. No.: 19/477,365

(22) PCT Filed: Nov. 27, 2024
(86) PCT No.: PCT/JP2024/041917

§ 371 Date: Oct. 21, 2025

(30) Foreign Application Priority Data
Dec. 14, 2023 (JP) 2023-210887

(51) Int. Cl. B60R 13/02; B60R 13/08

(52) U.S. Cl. CPC B60R 13/02; B60R 13/08

(57) ABSTRACT

A vehicle ceiling interior material for covering a body outer panel of a ceiling of an automobile from a boarding space side includes a laminated structure having laminated multiple layers. At least one of the multiple layers is a ceiling base material containing a thermal radiation absorbing material M that absorbs thermal radiation R.

### CROSS-REFERENCE TO RELATED APPLICATIONS

The present application is a 35 U.S.C. § 371 U.S. National Phase entry of, and claims priority to, PCT Application No. PCT/JP2024/041917, filed Nov. 27, 2024, which claims priority to Japanese Patent Application No. 2023-210887, filed Dec. 14, 2023, which is hereby incorporated herein by reference in its entirety for all purposes.

### BACKGROUND

The present disclosure relates to a vehicle ceiling interior material.

When a body outer panel of a vehicle ceiling is heated by sunlight, heat is radiated from the body outer panel. During summer, when the heat enters a boarding space, high temperature in the boarding space will increase in energy use of an air conditioner.

As a technology to address this problem, there is known, for example, a technology for vehicle ceiling materials disclosed in JP2013-129308A. In this technology, an infrared reflective layer is bonded to a backside fiber-reinforced layer that reinforces the vehicle ceiling material. This allows the vehicle ceiling material to shield the heat radiated from the body outer panel of the ceiling.

Incidentally, aluminum vapor-deposited film (metal film) is used for the infrared reflective layer of the vehicle ceiling material. Therefore, it is necessary to take measures against short circuits such as providing a protective layer to the vehicle ceiling material to insulate the electric wiring inside the vehicle and the infrared reflective layer.

There has been a conventional need for a vehicle ceiling interior material that suppresses thermal radiation reaching the boarding space from the body outer panel of the ceiling without using a metal film that reflects infrared radiation.

### SUMMARY

Firstly, a first disclosure relates to a vehicle ceiling interior material that covers a body outer panel of a vehicle ceiling from a boarding space side. The ceiling interior material has a laminated structure in which a plurality of layers are laminated from the body outer panel side to the boarding space side. The laminated structure includes a thermal radiation absorbing layer, which is a layer containing a thermal radiation absorbing material that absorbs thermal radiation reaching an inside the layer.

According to the vehicle ceiling interior material of the first disclosure, the thermal radiation absorbing layer included in the laminated structure absorbs thermal radiation that is about to enter the boarding space from the body outer panel of the ceiling by the thermal radiation absorbing material. This makes it possible to provide a vehicle ceiling interior material that can suppress thermal radiation reaching the boarding space from the body outer panel of the ceiling without using a metal film that reflects the thermal radiation.

In the vehicle ceiling interior material according to a second disclosure, the thermal radiation from the thermal radiation absorbing material is non-directional.

According to the vehicle ceiling interior material of the first disclosure, the temperature of the thermal radiation absorbing material that absorbs thermal radiation increases in the thermal radiation absorbing layer. The thermal radiation absorbing material dissipates the absorbed thermal energy through thermal radiation. According to the vehicle ceiling interior material of the second disclosure, the thermal radiation from the thermal radiation absorbing material is non-directional and is radiated in all directions. Therefore, a part of the thermal radiation from the thermal radiation absorbing material is directed to the outside of the boarding space. As a result, the vehicle ceiling interior material can suppress the thermal radiation reaching the boarding space.

In the vehicle ceiling interior material according to the third disclosure, the thermal radiation absorbing layer is provided to cover the entire body outer panel from the boarding space side.

According to the vehicle ceiling interior material of the third disclosure, heat radiated from any part of the body outer panel of the ceiling passes through the thermal radiation absorbing layer of the laminated structure when reaching the boarding space. As a result, the vehicle ceiling interior material can suppress the thermal radiation that passes through the thermal radiation absorbing layer of the laminated structure and reaches the boarding space.

In the vehicle ceiling interior material according to the fourth disclosure, the laminated structure includes a heat insulation layer, which is a layer having a thermal conductivity lower than a thermal conductivity of the thermal radiation absorbing layer. The heat insulation layer is located closer to the boarding space side than the thermal radiation absorbing layer. The heat insulation layer works by reducing heat transfer from the thermal radiation absorbing layer to the boarding space.

According to the vehicle ceiling interior material of the first disclosure, the temperature of the thermal radiation absorbing material that has absorbed thermal radiation increases in the thermal radiation absorbing layer. The thermal radiation absorbing material then transfers the absorbed thermal energy to the surroundings through heat conduction. According to the vehicle ceiling interior material of the fourth disclosure, the heat insulation layer prevents the heat of the thermal radiation absorbing layer from being transferred to the boarding space side by heat conduction. As a result, the vehicle ceiling interior material can suppress the heat reaching the boarding space.

By having each of the above configurations, the present disclosure can provide a vehicle ceiling interior material that suppresses thermal radiation reaching the boarding space from the body outer panel of the ceiling without using a metal film that reflects infrared radiation.

### BRIEF DESCRIPTION OF THE DRAWINGS

FIG. 1 is a schematic view of an automobile to illustrate a vehicle ceiling interior material according to a first embodiment.

FIG. 2 is an enlarged view of section II in FIG. 1.

FIG. 3 is a schematic view of an automobile to illustrate a vehicle ceiling interior material according to a second embodiment.

FIG. 4 is an enlarged view of section IV in FIG. 3.

### DETAILED DESCRIPTION

### First Embodiment

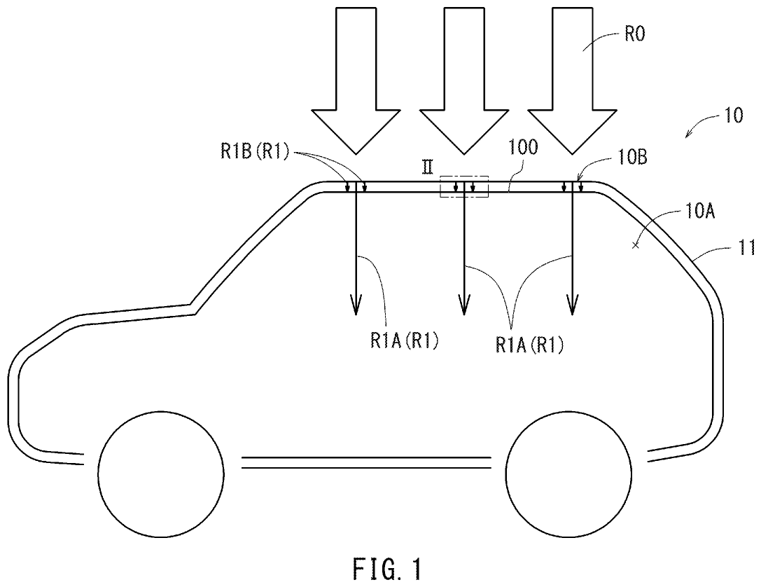

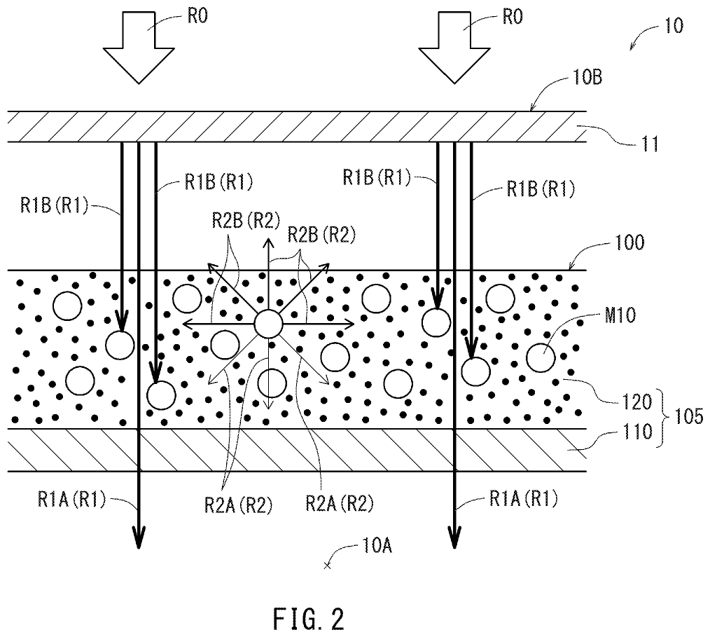

As shown in FIG. 1, an automobile 10, which is one type of “vehicle”, has a ceiling 10B. The ceiling 10B has a body outer panel 11. A vehicle ceiling interior material 100 according to the first embodiment of the present disclosure is provided on the ceiling 10B and covers the entire body outer panel 11 from the boarding space 10A side. As shown in FIG. 2, the ceiling interior material 100 has a layer laminated structure 105, which is provided with a plurality of layers (e.g., two layers). The layer laminated structure 105 has a ceiling base material 120 located on the body outer panel 11 side and a skin material 110 located on the boarding space 10A side.

The body outer panel 11 is expected to be heated by sunlight RO up to the maximum temperature of about 120° C. Therefore, the heated body outer panel 11 radiates thermal radiation R1. This thermal radiation R1 is mainly infrared radiation in the wavelength range of, for example, about 1 μm to 30 μm, and also partially includes electromagnetic waves from far infrared radiation to submillimeter waves (radio waves) with longer wavelengths.

### Composition of Skin Material

The skin material 110 is a layer that constitutes a design face of the ceiling 10B of the automobile 10 (see FIG. 1) and improves its aesthetics. In this embodiment, the skin material 110 is composed of, for example, a layer of non-woven fabric.

### Composition of Ceiling Base Material

The ceiling base material 120 is a layer that provides strength to allow the vehicle ceiling interior material 100 to retain its shape. For example, the ceiling base material 120 is stronger than the other layers. The ceiling base material may be a mixed laminate of multiple layers or a single layer. When the ceiling base material is a mixed laminate of multiple layers, the ceiling base material may be a laminate of a layer of thermosetting resin (e.g., semi-rigid polyurethane foam) and a layer of glass fiber to ensure strength. When the ceiling base material is composed of only a single layer, the ceiling base material may be, for example, a layer of matted thermoplastic sheet material mixed with glass fibers and polypropylene fibers. In these cases, the ceiling base material may have sufficient strength to resist deformation under a force approximately equal to the self-weight of the vehicle ceiling interior material 100.

As shown in FIG. 2, the ceiling base material 120 contains a thermal radiation absorbing material M10. The thermal radiation absorbing material M10 absorbs thermal radiation R1B, which is a portion of the thermal radiation R1 reaching inside the layer of the ceiling base material 120 from the body outer panel 11 of the ceiling 10B. As a result, the ceiling base material 120 suppresses the thermal radiation R1A out of the thermal radiation R1 that penetrates the ceiling base material and reaches the boarding space 10A. In other words, the ceiling base material 120 corresponds to the “thermal radiation absorbing layer” in the present disclosure. In this embodiment, carbon black, which can absorb a wide range of electromagnetic waves belonging to the wavelength range of ultraviolet radiation to infrared radiation, is used as the thermal radiation absorbing material M10. The thermal radiation absorbing material M10 may be, for example, granular.

The thermal radiation absorbing material M10 may be contained in any part of the ceiling base material 120. If the ceiling base material is composed of a laminate of a layer of thermoplastic resin and a layer of glass fiber, the thermal radiation absorbing material may be contained into the layer of the thermoplastic resin. When the ceiling member is composed of only a single foam resin layer, the thermal radiation absorbing material may be contained in a foam resin that constitutes the foam resin layer. FIG. 2 depicts the thermal radiation absorbing material M10 as being uniformly distributed throughout the entire ceiling base material 120.

In this embodiment, the ceiling base material 120 is provided to cover the entire body outer panel 11 of the ceiling 10B from the boarding space 10A side. Therefore, heat radiated from any part of the body outer panel 11 of the ceiling 10B will also passes through the ceiling base material 120 when reaching the boarding space 10A.

After absorbing thermal radiation RIB from the body outer panel 11, the radiation absorbing material's M10 temperature increases. The thermal radiation absorbing material M10 with the increased temperature dissipates the absorbed thermal energy by thermal radiation R2. The thermal radiation R2 from the thermal radiation absorbing material M10 is non-directional, which is radiated in all directions.

### Function of Vehicle Ceiling Interior Material

Hereinafter, the function of the vehicle ceiling interior material 100 according to the above-described embodiment will be described mainly with reference to FIG. 2.

In an automobile 10, when the body outer panel 11 of the ceiling 10B is heated by sunlight R0, thermal radiation R1 from this body outer panel 11 toward the interior of the automobile 10 is generated. This thermal radiation R1 attempts to enter the boarding space 10A passing through the ceiling base material 120. However, a portion of the thermal radiation R1, the thermal radiation R1B, is absorbed by the thermal radiation absorbing material M10. Therefore, only a part of the thermal radiation R1, designated as R1A, passes through the ceiling base material 120 and reaches the boarding space 10A.

The temperature of the thermal radiation absorbing material M10 that has absorbed thermal radiation R1B in the ceiling base material 120 increases. Then, the thermal radiation absorbing material M10, which has absorbed the thermal radiation R1B and its temperature has increased, dissipates the absorbed thermal energy by the thermal radiation R2. Here, the thermal radiation R2 from the thermal radiation absorbing material M10 is non-directional and is radiated in all directions. Therefore, only a portion of the thermal radiation R2, specifically the thermal radiation R2A, reaches the boarding space 10A side, while the remaining thermal radiation R2B is directed back toward the body outer panel 11 side of the ceiling 10B or within the layer of the ceiling base material 120.

As a result of these functions, the vehicle ceiling interior material 100 suppresses the thermal radiation (thermal radiation R1A and thermal radiation R2A) originating from sunlight R0 that is about to enter the boarding space 10A, and reduces the effect of the temperature increase in the boarding space 10A caused by this thermal radiation.

### Effect

According to the above-described vehicle ceiling interior material 100, the ceiling base material 120 included in the laminated structure 105 absorbs the thermal radiation RIB that is about to enter the boarding space 10A from the body outer panel 11 of the ceiling 10B by the thermal radiation absorbing material M10. This makes it possible to provide a vehicle ceiling interior material 100 that can suppress the thermal radiation R1A reaching the boarding space 10A from the body outer panel 11 of the ceiling 10B without using a metal film that reflects the thermal radiation.

According to the vehicle ceiling interior material 100, the temperature of the thermal radiation absorbing material M10 that has absorbed thermal radiation R1B increases in the ceiling base material 120. The thermal radiation absorbing material M10 then dissipates the absorbed thermal energy by thermal radiation R2. The thermal radiation R2 from the thermal radiation absorbing material M10 is non-directional and is radiated in all directions. Therefore, a portion of the thermal radiation R2 from the thermal radiation absorbing material M10 is directed to the outside of the boarding space 10A. As a result, the vehicle ceiling interior material 100 can suppress the thermal radiation R2A reaching the boarding space 10A.

According to the vehicle ceiling interior material 100, heat radiated from any part of the body outer panel 11 of the ceiling 10B passes through the ceiling base material 120 of the laminated structure 105 when reaching the boarding space 10A. As a result, the vehicle ceiling interior material 100 can suppress thermal radiation RIA that passes through the ceiling base material 120 of the laminated structure 105 to reach the boarding space 10A.

According to each configuration of the vehicle ceiling interior material 100, it is possible to provide a vehicle ceiling interior material 100 that suppresses thermal radiation (thermal radiation R1A and thermal radiation R2A) reaching the boarding space 10A from the body outer panel 11 of the ceiling 10B without using a metal film that reflects infrared radiation.

### Second Embodiment

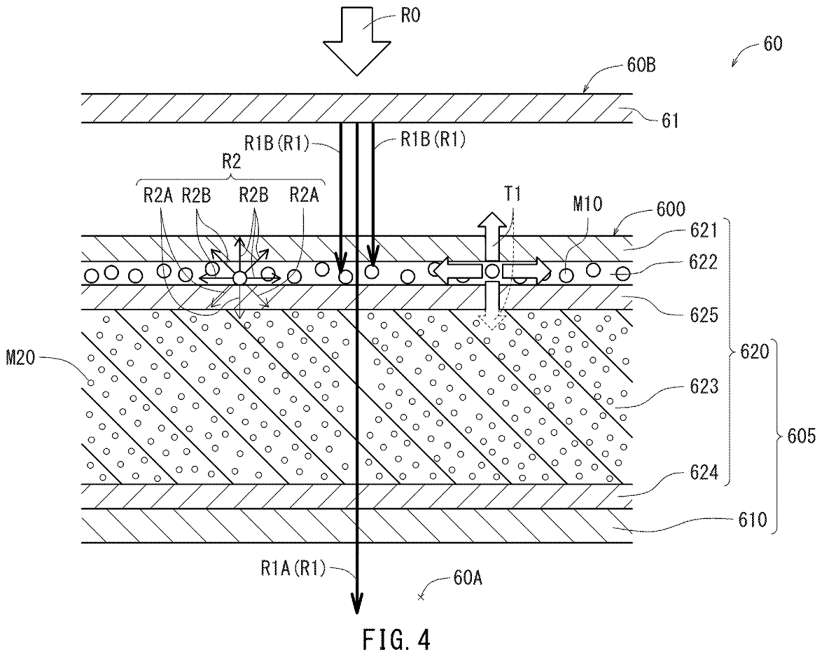

Subsequently, the configuration of a vehicle ceiling interior material 600 according to a second embodiment of the present disclosure will be described with reference to FIG. 4. The vehicle ceiling interior material 600 according to the second embodiment is a modified embodiment of the vehicle ceiling interior material 100 according to the first embodiment. Therefore, for the components common to the vehicle ceiling interior material 100 according to the first embodiment, reference numerals are assigned by adding “500” to the reference numerals used in the first embodiment to correspond to each component of the vehicle ceiling interior material 100 according to the first embodiment, and detailed descriptions are omitted.

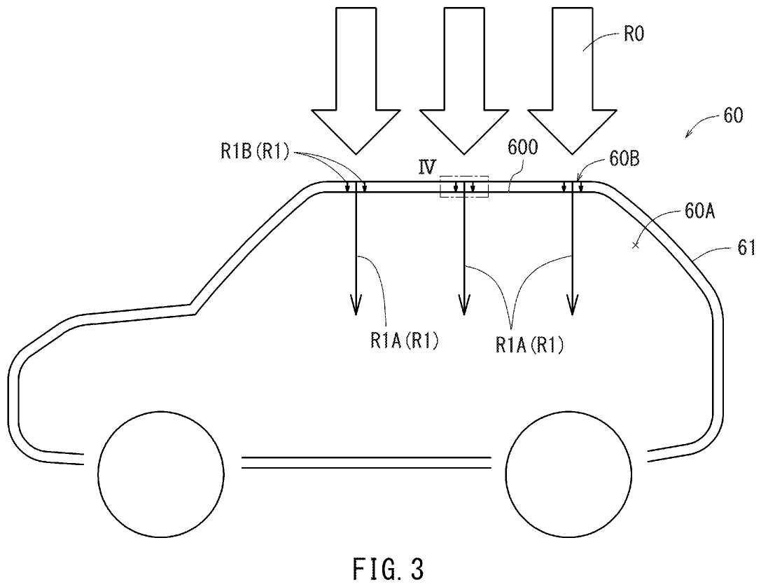

As shown in FIG. 3, the vehicle ceiling interior material 600 according to the second embodiment of the present disclosure is provided on a ceiling 60B of an automobile 60. The ceiling interior material 600 covers the entire body outer panel 61 of the ceiling 60B from the boarding space 60A side. As shown in FIG. 4, the vehicle ceiling interior material 600 has a laminated structure 605 including multiple layers. The laminated structure 605 has a ceiling base material 620 located on the body outer panel 61 side and a skin material 610 located on the boarding space 60A side.

### Structure of Ceiling Base Material

In the ceiling base material 620, five layers are laminated in the following order from the body outer panel 61 side of the ceiling 60B toward the boarding space 60A side: a protective layer 621, a thermal radiation absorbing layer 622, an absorbing layer adhesive layer 625, a heat insulation layer 623, and a skin material adhesive layer 624. In this embodiment, each layer constituting the ceiling base material 620 is bonded using an appropriately selected method.

### Structure of Protective Layer

The protective layer 621 is a nonwoven fabric layer of interlaced fibers mainly made of thermoplastic resin such as polyester. This protective layer 621 serves as a cushioning material interleaved between the thermal radiation absorbing layer 622 and the body outer panel 61 of the ceiling 60B. In this embodiment, the fiber density of the nonwoven fabric is uniform per unit area.

### Structure of Thermal Radiation Absorbing Layer

The thermal radiation absorbing layer 622 is a film-like layer of thermoplastic resin (e.g., polyamide) in which the thermal radiation absorbing material M10 is contained. For the thermal radiation absorbing material M10 contained in the thermal radiation absorbing layer 622, the same as the thermal radiation absorbing material M10 used in the vehicle ceiling interior material 100 according to the first embodiment is used. That is, the thermal radiation absorbing material M10 absorbs the thermal radiation R1B that reaches within the thermal radiation absorbing layer 622, thereby increasing the temperature. Furthermore, the thermoplastic resin constituting the thermal radiation absorbing layer 622 ensures to maintain the stable state against the same level of temperature increase (e.g., temperature increase of up to 120° C.) as the temperature increase due to the absorption of the thermal radiation RIB by the thermal radiation absorbing material M10.

In this embodiment, the thermal radiation absorbing material M10 is blended into the thermoplastic resin, which serves as the raw material for the thermal radiation absorbing layer 622, in an amount of, for example, 1 to 10% by weight. Further, the thermal radiation absorbing layer 622 is formed by inflation molding (a method of obtaining a tubular resin molded product by introducing cooling air into the tube while extruding the molten resin into a tubular shape) of the thermoplastic resin contained with the thermal radiation absorbing material M10. However, the thermal radiation absorbing layer 622 may be formed, for example, by cast molding (a method of obtaining a strip-shaped resin molded product by contacting a cooling roll while extruding the molten resin into a strip shape).

The thermal radiation absorbing layer 622 is airtight, which contributes to soundproofing and prevents air and dust flow between the boarding space and the body outer panel. Therefore, sound propagation between the body outer panel 61 of the ceiling 60B and the boarding space 60A is conducted via the thermal radiation absorbing layer 622. Since the thermal radiation absorbing layer 622 has a higher density than air (not shown), sound pressure is suppressed. In other words, the thermal radiation absorbing layer 622 has a soundproofing functionality between the body outer panel 61 of the ceiling 60B and the boarding space 60A.

The thermal radiation absorbing layer 622 also prevents the air in the boarding space 60A (not shown) from flowing to the body outer panel 61 of the ceiling 60B due to its airtight nature.

### Structure of Heat Insulation Layer

The heat insulation layer 623 is configured to have a layer of plastic foam (e.g., semi-rigid polyurethane having a heat resistance temperature of 120° C. or higher) containing a plurality of air bubbles M20, which is integrated by being interposed between layers of reinforcing fibers (not shown. e.g., glass fiber) from both the front and rear sides. Reinforcing fibers provide the heat insulation layer 623 with structural strength to retain the shape of the ceiling material 600. This heat insulation layer 623 is provided at a position that is closer to the boarding space 60A side than the thermal radiation absorbing layer 622. The heat insulation layer 623 is configured so that its thermal conductivity is lower than both a thermal conductivity of the thermal radiation absorbing layer 622 and a thermal conductivity of the skin material 610.

### Structure of Skin Material Adhesive Layer

The skin material adhesive layer 624 is a film-like layer made of thermoplastic resin (e.g., polyamide). The skin material adhesive layer 624 serves as a bridge to adhere the skin material 610 to the ceiling base material 620. The skin material adhesive layer 624 may be formed by a method similar to the method described above for forming the thermal radiation absorbing layer 622.

### Structure of Absorbing Layer Adhesive Layer

The absorbing layer adhesive layer 625 is a layer that has exactly the same structure as the skin material adhesive layer 624 and serves as a bridge to adhere the heat insulation layer 623 to the thermal radiation absorbing layer 622. The method for forming the absorbing layer adhesive layer 625 is the same as the method for forming the skin material adhesive layer 624.

### Function of Vehicle Ceiling Interior Material

Next, the function of the vehicle ceiling interior material 600 according to the above-described embodiment will be described mainly with reference to FIG. 4.

In an automobile 60, when the body outer panel 61 of the ceiling 60B is heated by sunlight R0, thermal radiation R1 is generated from this body outer panel 61 toward the interior of the automobile 60. This thermal radiation R1 attempts to enter the boarding space 60A passing through the ceiling base material 620. However, a portion of the thermal radiation R1, the thermal radiation RIB, is absorbed by the thermal radiation absorbing material M10. Therefore, the thermal radiation RIA that passes through the ceiling base material 620 and reaches the boarding space 60A is only a portion of the thermal radiation R1.

Further, the temperature of the thermal radiation absorbing material M10 that has absorbed thermal radiation RIB in the thermal radiation absorbing layer 622 increases. Then, the thermal radiation absorbing material M10, which has absorbed the thermal radiation R1B and its temperature has increased, dissipates the absorbed thermal energy by the thermal radiation R2. Here, the thermal radiation R2 from the thermal radiation absorbing material M10 is non-directional and is radiated in all directions. Therefore, only a portion of the thermal radiation R2 from the thermal radiation absorbing material M10, specifically the thermal radiation R2A, is directed toward the boarding space 60A side, while the remaining thermal radiation R2B is directed toward the body outer panel 61 side of the ceiling 60B or in a direction toward the inside of the layer of the thermal radiation absorbing layer 622.

As a result of these functions, the vehicle ceiling interior material 600 suppresses the thermal radiation (thermal radiation R1A and thermal radiation R2A) originating from sunlight R0 that is about to enter the boarding space 60A, and reduces the effect of the temperature increase in the boarding space 60A caused by this thermal radiation.

Further, the temperature of the thermal radiation absorbing material M10 that has absorbed the thermal radiation RIB from the body outer panel 61 of the ceiling 60B increases in the thermal radiation absorption layer 622. The thermal radiation absorbing material M10 transfers the absorbed thermal energy to the surroundings through heat conduction T1. Since this heat conduction T1 is non-directional, the heat attempts to move in all directions including the body outer panel 61 side and the boarding space 60A side. In contrast, the heat insulation layer 623 suppresses the heat transfer of the heat conduction T1 to the boarding space 60A side due to its low thermal conductivity (see FIG. 4, which illustrates that the heat conduction T1 transferred to the boarding space 60A side is shown by a dashed arrow in the heat insulation layer 623).

Further, the sound propagation between the body outer panel 61 of the ceiling 60B and the boarding space 60A is conducted through the air (not shown) and the thermal radiation absorbing layer 622. In this way, the sound pressure is suppressed in the sound propagation between the body outer panel 61 of the ceiling 60B and the boarding space 60A.

The thermal radiation absorbing layer 622 also prevents the air in the boarding space 60A from flowing to the body outer panel 61 side. In this way, dust (not shown) in the boarding space 60A flows with the air to the vehicle ceiling interior material 600, thereby preventing the dust from adhering to the skin material 610.

### Effect

According to the vehicle ceiling interior material 600 described above, the temperature of the thermal radiation absorbing material M10, which has absorbed the thermal radiation R1B increases in the thermal radiation absorbing layer 622. The thermal radiation absorbing material M10 then transfers the absorbed thermal energy to the surroundings by heat conduction T1. Positioned closer to the boarding space 60A side, the heat insulation layer 623 prevents the heat conduction T1 from the thermal radiation absorbing layer 622, ensuring that absorbed heat does not significantly increase the boarding space 60A temperature (see heat conduction T1 depicted by the dashed arrow in FIG. 4). This allows the vehicle ceiling interior material 600 to suppress the heat reaching the boarding space 60A.

According to each configuration of the vehicle ceiling interior material 600, it is possible to provide a vehicle ceiling interior material 600 for preventing the thermal radiation (thermal radiation R1A and thermal radiation R2A) reaching the boarding space 60A from the body outer panel 61 of the ceiling 60B without using a metal film that reflects infrared radiation.

### Other Embodiments

The embodiments for carrying out the present disclosure have been described above with reference to the embodiments described above. However, it would be obvious for a person with ordinary skill in the art that various alternatives, corrections, and/or modifications may be made without departing from the object of the present disclosure. More specifically, the embodiments for carrying out the object of the present invention may include all alternatives, corrections, and/or modifications without departing from the gist and the object of the claims appended to the present specification. For example, various modified embodiments as follows may be carried out as embodiments for carrying out the present disclosure.

In the present disclosure, the thermal radiation absorbing material shall not be limited to carbon black, and any appropriately selected infrared absorbing material may be used. Examples of such infrared absorbing materials may include, for example, tungsten oxide fine particles, composite tungsten oxide fine particles, diimonium-based compounds, alminium-based compounds, phthalocyanine-based compounds, organometallic complexes, cyanine-based compounds, azo compounds, polymethine-based compounds, quinone-based compounds, diphenylmethane-based compounds, triphenylmethane-based compounds, etc. Further, in the present disclosure, a combination of multiple types of thermal radiation absorbing materials with different absorption wavelengths may be used. In this case, some of the thermal radiation absorbing materials may also serve as electromagnetic wave absorbing materials that effectively absorb electromagnetic waves in the far-infrared to submillimeter wave (radio wave) range.

In the present disclosure, the thermal radiation absorbing material may have thermal radiation with directivity. Such a thermal radiation absorbing material may be obtained, for example, by forming the thermal radiation absorbing material into flat particles. Even in this case, by adding the thermal radiation absorbing material in the thermal radiation absorbing layer in an irregular orientation, the thermal radiation observed as a whole in the thermal radiation absorbing layer may be made non-directional.

In the vehicle ceiling interior material according to the second embodiment, the thermal radiation absorbing material shall not be limited to being added in the airtight layer between the protective layer and the heat insulation layer. In other words, in the vehicle ceiling interior material, the thermal radiation absorbing material may be contained in any of the protective layer, the absorbing layer adhesive layer, the heat insulation layer, or the skin material adhesive layer. Here, when the protective layer contains the thermal radiation absorbing material, a method may be adopted in which fibers are produced from a material resin containing the thermal radiation absorbing material, and a nonwoven fabric made from these fibers is used as the protective layer. Further, when the absorbing layer adhesive layer or the skin material adhesive layer contains a thermal radiation absorbing material, a method may be adopted in which the adhesive layer is produced using a material resin mixed with the thermal radiation absorbing material as the raw material. Furthermore, when the heat insulation layer contains a thermal radiation absorbing material, a method may be adopted in which the thermal radiation absorbing material is pre-mixed into the raw materials of the insulation layer (for example, polyol or polyisocyanate when the heat insulation layer is made of urethane resin).

In the vehicle ceiling interior material according to the second embodiment, the specific materials of the thermal radiation absorbing layer and the adhesive layer shall not be limited to those described in the second embodiment. That is, the material of the thermal radiation absorbing layer and the adhesive layer may be polypropylene or polyethylene terephthalate. Likewise, the specific materials of the heat insulation layer shall not be limited to those described in the second embodiment. That is, the material of the heat insulation layer may be modified polyphenylene oxide.

1. A vehicle ceiling interior material configured to cover a body outer panel of a vehicle ceiling from a boarding space side comprising
a laminated structure having at least one of laminated multiple layers,
wherein the at least one of multiple layers is a thermal radiation absorbing layer including a thermal radiation absorbing material that absorbs thermal radiation.

2. The vehicle ceiling interior material according to claim 1, wherein thermal radiation from the thermal radiation absorbing material is non-directional.

3. The vehicle ceiling interior material according to claim 1, wherein the thermal radiation absorbing layer is provided to cover an entire body outer panel from the boarding space side.

4. The vehicle ceiling interior material according to claim 1, wherein the at least one of multiple layers is a heat insulation layer positioned closer to the boarding space, wherein the heat insulation layer has a lower thermal conductivity than the thermal radiation absorbing layer.

5. The vehicle interior material according to claim 1, wherein the at least one of multiple layers is a skin material composed of nonwoven fabric and located on the boarding space side of the ceiling.

6. The vehicle interior material according to claim 1, wherein the thermal radiation absorbing layer includes thermal radiation absorbing material and thermoplastic resin.

7. A vehicle ceiling interior material comprising:
a thermal radiation absorbing layer having a thermal radiation absorbing material for absorbing thermal radiation from a body outer panel;
a heat insulation layer having a lower thermal conductivity than the thermal radiation absorbing layer for preventing heat transfer;
an adhesive layer; and
a protective layer for cushioning and soundproofing.

8. The vehicle ceiling interior material of claim 7 further comprises a ceiling base material selected from a group consisting of thermosetting resin, glass fiber, or 15 thermoplastic materials.

9. The vehicle ceiling interior material of claim 7 further comprises a skin material made of nonwoven fabric.

10. The vehicle ceiling interior material of claim 7, wherein the thermal radiation absorbing layer comprises a thermoplastic resin layer composed of thermoplastic resin for providing structural stability and heat resistance.

11. The vehicle ceiling interior material of claim 7, wherein the thermal radiation absorbing layer is airtight and configured to prevent air and dust flow between a boarding space and the body outer panel.
